(19) United States
(12) Patent Application Publication
(10) Pub. No.: US 2026/0197145 A1
(43) Pub. Date: Jul. 9, 2026

(54) DEDICATED REFERENCE SIGNALING FOR CELL ACTIVATION

(71) Applicant: QUALCOMM Incorporated, San Diego, CA (US)

(72) Inventors: Kianoush HOSSEINI, San Diego, CA (US); Changhwan PARK, San Diego, CA (US); Heechoon LEE, San Diego, CA (US); Paolo MINERO, La Jolla, CA (US)

(21) Appl. No.: 19/440,389

(22) Filed: Jan. 5, 2026

Related U.S. Application Data
(60) Provisional application No. 63/743,227, filed on Jan. 8, 2025.

(51) Int. Cl. H04L 5/00

(52) U.S. Cl. CPC H04L 5/0094; H04L 5/0005

(57) ABSTRACT

Methods, systems, and devices for wireless communications are described. A network entity may transmit a control message (e.g., a control message including an instruction to activate a secondary cell (SCell)) which may include an indication of one or more aperiodic narrowband reference signals for SCell activation. A user equipment (UE) may monitor for and receive the narrowband reference signals based on the dynamic control signaling indicating the narrowband reference signals. The network may indicate the resources for the narrowband reference signals via radio resource control (RRC) signaling, dynamic control signaling (e.g., a media access control (MAC) control element (CE) or downlink control information (DCI) message that indicates that the UE is to activate the SCell), or both.

### CROSS REFERENCES

The present Application for Patent claims benefit of U.S. Provisional Patent Application No. 63/743,227 by HOSSEINI et al., entitled “DEDICATED REFERENCE SIGNALING FOR CELL ACTIVATION,” filed Jan. 8, 2025, assigned to the assignee hereof, and expressly incorporated herein.

### FIELD OF TECHNOLOGY

The following relates to wireless communications, including dedicated reference signaling for cell activation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control signaling indicating a primary cell and one or more secondary cells, receiving a control message indicating activation of a secondary cell of the one or more secondary cells, the control message including an indication of a set of aperiodic narrowband reference signals for a subchannel of the secondary cell, receiving the set of aperiodic narrowband reference signals via the subchannel of the secondary cell in accordance with the control message, and communicating one or more messages via the secondary cell in accordance with one or more measurements of the set of aperiodic narrowband reference signals.

A UE for wireless communications is described. The UE may include one or more memories storing processor executable code, a transceiver, and one or more processors coupled with the one or more memories and the transceiver. The one or more processors may individually or collectively be operable to execute the code to cause the UE to receive, via the transceiver, control signaling indicating a primary cell and one or more secondary cells, receive, via the transceiver, a control message indicating activation of a secondary cell of the one or more secondary cells, the control message including an indication of a set of aperiodic narrowband reference signals for a subchannel of the secondary cell, receive, via the transceiver, the set of aperiodic narrowband reference signals via the subchannel of the secondary cell in accordance with the control message, and communicate, via the transceiver, one or more messages via the secondary cell in accordance with one or more measurements of the set of aperiodic narrowband reference signals.

Another UE for wireless communications is described. The UE may include means for receiving control signaling indicating a primary cell and one or more secondary cells, means for receiving a control message indicating activation of a secondary cell of the one or more secondary cells, the control message including an indication of a set of aperiodic narrowband reference signals for a subchannel of the secondary cell, means for receiving the set of aperiodic narrowband reference signals via the subchannel of the secondary cell in accordance with the control message, and means for communicating one or more messages via the secondary cell in accordance with one or more measurements of the set of aperiodic narrowband reference signals.

A non-transitory computer-readable medium storing code for wireless communications is described. The code may include instructions executable by one or more processors to receive control signaling indicating a primary cell and one or more secondary cells, receive a control message indicating activation of a secondary cell of the one or more secondary cells, the control message including an indication of a set of aperiodic narrowband reference signals for a subchannel of the secondary cell, receive the set of aperiodic narrowband reference signals via the subchannel of the secondary cell in accordance with the control message, and communicate one or more messages via the secondary cell in accordance with one or more measurements of the set of aperiodic narrowband reference signals.

Some examples of the method, UEs, and non-transitory computer-readable medium described herein may further include operations, features, means, or instructions for receiving, via the control signaling, an indication of a set of candidate time and frequency resources for the set of aperiodic narrowband reference signals and receiving, via the control message, an indication of time and frequency resources of the set of candidate time and frequency resources for the subchannel of the secondary cell, where the set of aperiodic narrowband reference signals may be received via the indicated time and frequency resources.

Some examples of the method, UEs, and non-transitory computer-readable medium described herein may further include operations, features, means, or instructions for receiving, via the control signaling, an indication of a set of candidate frequency resources for the set of aperiodic narrowband reference signals and receiving, via the control message, an indication of time resources for the set of aperiodic narrowband reference signals and an indication of frequency resources of the set of candidate frequency resources for the subchannel of the secondary cell, where the set of aperiodic narrowband reference signals may be received via the time and frequency resources.

Some examples of the method, UEs, and non-transitory computer-readable medium described herein may further include operations, features, means, or instructions for receiving, via the control message, an indication of a resource allocation of time and frequency resources for the set of aperiodic narrowband reference signals, where the set of aperiodic narrowband reference signals may be received via the indicated time and frequency resources.

Some examples of the method, UEs, and non-transitory computer-readable medium described herein may further include operations, features, means, or instructions for receiving, via the control signaling, the control message, or both, an indication of time and frequency resources for receiving a first aperiodic narrowband reference signal, where time and frequency resources of a remainder of the set of aperiodic narrowband reference signals may be based on the indication of the time and frequency resources for the first aperiodic narrowband reference signal.

In some examples of the method, UEs, and non-transitory computer-readable medium described herein, each aperiodic narrowband reference signal of the set of aperiodic narrowband reference signals include a primary synchronization signal, a secondary synchronization reference signal, a physical broadcast channel, or any combination thereof.

Some examples of the method, UEs, and non-transitory computer-readable medium described herein may further include operations, features, means, or instructions for receiving the control message including the indication of the set of aperiodic narrowband reference signals may be based on the secondary cell being a known cell at the UE, the secondary cell being an unknown cell at the UE, the secondary cell being located within a first bandwidth or frequency range, a received transmission configuration indicator state at the UE, or any combination thereof.

In some examples of the method, UEs, and non-transitory computer-readable medium described herein, one or more occasions of a set of multiple SSBs and one or more occasions of the set of aperiodic narrowband reference signals do not align across a set of component carriers.

In some examples of the method, UEs, and non-transitory computer-readable medium described herein, a first aperiodic narrowband reference signal of the set of aperiodic narrowband reference signals may be received at least a threshold time offset after reception of the control message.

Some examples of the method, UEs, and non-transitory computer-readable medium described herein may further include operations, features, means, or instructions for transmitting a capability message indicating that the UE supports dynamic activation of the one or more secondary cells, where receiving the control message may be based on the capability message.

Some examples of the method, UEs, and non-transitory computer-readable medium described herein may further include operations, features, means, or instructions for receiving a second control message including an indication of a second set of aperiodic narrowband reference signals for a subchannel of an additional secondary cell that may be deactivated, receiving the second set of aperiodic narrowband reference signals via the subchannel of the additional secondary cell in accordance with the second control message, and transmitting a report indicating one or more measurements of the additional secondary cell based on receiving the second set of aperiodic narrowband reference signals.

In some examples of the method, UEs, and non-transitory computer-readable medium described herein, the control message includes a media access control (MAC) control element (CE), or a downlink control information (DCI) message.

In some examples of the method, UEs, and non-transitory computer-readable medium described herein, control signaling includes an indication of a set of multiple periodic synchronization signal blocks (SSBs) for at least the primary cell.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports dedicated reference signaling for cell activation in accordance with one or more aspects of the present disclosure.

FIG. 2 shows an example of a timeline that supports dedicated reference signaling for cell activation in accordance with one or more aspects of the present disclosure.

FIG. 3 shows an example of a timeline that supports dedicated reference signaling for cell activation in accordance with one or more aspects of the present disclosure.

FIG. 4 shows an example of a process flow that supports dedicated reference signaling for cell activation in accordance with one or more aspects of the present disclosure.

FIGS. 5 and 6 show block diagrams of devices that support dedicated reference signaling for cell activation in accordance with one or more aspects of the present disclosure.

FIG. 7 shows a block diagram of a communications manager that supports dedicated reference signaling for cell activation in accordance with one or more aspects of the present disclosure.

FIG. 8 shows a diagram of a system including a device that supports dedicated reference signaling for cell activation in accordance with one or more aspects of the present disclosure.

FIGS. 9 through 11 show flowcharts illustrating methods that support dedicated reference signaling for cell activation in accordance with one or more aspects of the present disclosure.

### DETAILED DESCRIPTION

Some wireless communications systems may support carrier aggregation and communications across multiple carriers or cells. For example, the network may configure a user equipment (UE) with a primary cell (PCell) and one or more secondary cells (SCells). Support of such multiple cells may increase throughput for devices. However, activation of inactive SCells may result in increased latency. Maintaining all SCells as active (e.g., even in cases where the SCells are not being utilized for traffic) may result in reduced latency due to activation, but may also result in a large power expenditure. Alternatively, maintaining some or all unutilized SCells in an inactive state may result in power savings, but increased latency due to time delays each time the network instructs the UE to activate one or more inactive SCells. For example, a UE may receive a control message instructing the UE to activate an SCell. Within a threshold amount of time, the UE may have processed the control message and may be prepared and able to activate the SCell. However, the UE may not be able to activate the cell until receiving a next available synchronization signal block (SSB) via the SCell, after which the UE may perform measurements and timing alignment for the SCell. SSBs may be periodic, so the UE may have to wait until the next SSB, resulting in unnecessary delays, increased system latency, and reduced throughput.

According to techniques described herein, the network entity may transmit a control message (e.g., a control message including an instruction to activate an SCell) which may include an indication of one or more aperiodic narrowband reference signals for SCell activation. The UE may monitor for and receive the narrowband reference signals based on the dynamic control signaling indicating the narrowband reference signals (e.g., instead of waiting for a next SSB to perform timing acquisition etc.). The reference signals may include primary synchronization signals (PSSs), secondary synchronization signals (SSSs), or the like.

In some examples, a narrowband reference signal may refer to a signal with a bandwidth that is not greater than a defined or threshold value. Such a threshold value may be the same as a bandwidth of a PSS, an SSS, a PBCH, or such a threshold value may define a reference bandwidth to be the same as an SSB. In some examples, the value of the narrowband reference signal may be defined in one or more standards documents or may be based on a UE capability (e.g., which the UE may report via capability information signaling). The network may indicate the resources for the narrowband reference signals via radio resource control (RRC) signaling, dynamic control signaling (e.g., a media access control (MAC) control element (CE) or downlink control information (DCI) message that indicates that the UE is to activate the SCell), or both. For instance, the RRC signaling may indicate candidate time resources, frequency resources, or both, for the narrowband reference signals, and the control message may indicate one of the candidate sets of resources. In some examples, the RRC signaling may indicate some resources information (e.g., frequency domain resources) and the control message may indicate a remainder of resource information (e.g., time resources, or both time resources and one of a set of configured candidate frequency resources). In some examples, the control message may include an indication of both time and frequency resources for the narrowband reference signals. The time and frequency resources for the narrowband reference signals may include a subchannel of a bandwidth of the SCell (e.g., the subchannel may include a number of resource blocks (RBs) or resource elements (REs) on the SCell and may be contiguous or noncontiguous, and may span a frequency range or set of frequency ranges that is less than (e.g., does not span) an entire band or bandwidth of the SCell).

Aspects of the disclosure are initially described in the context of wireless communications systems. Aspects of the disclosure are further illustrated by and described with reference to timelines and process flows. Aspects of the disclosure are further illustrated by and described with reference to apparatus diagrams, system diagrams, and flowcharts that relate to dedicated reference signaling for cell activation.

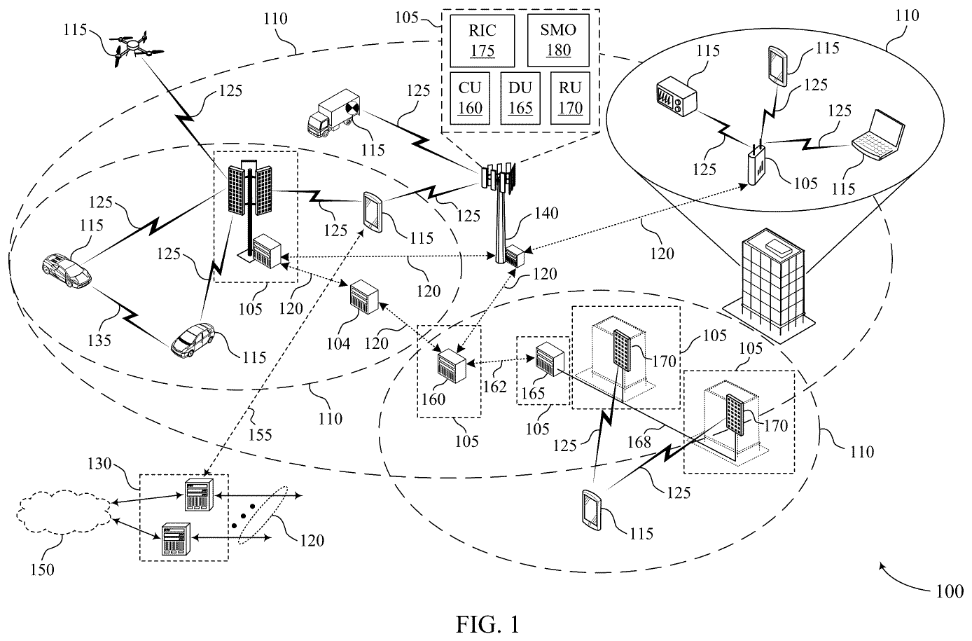

FIG. 1 shows an example of a wireless communications system 100 that supports dedicated reference signaling for cell activation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L 3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L 1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support dedicated reference signaling for cell activation as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling

unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

According to techniques described herein, the network entity may transmit a control message (e.g., a control message including an instruction to activate an SCell) which may include an indication of one or more aperiodic narrowband reference signals for SCell activation. The UE 115 may monitor for and receive the narrowband reference signals based on the dynamic control signaling indicating the narrowband reference signals (e.g., instead of waiting for a next SSB to perform timing acquisition etc.). The reference signals may include PSSs, SSSs, or the like. The network may indicate the resources for the narrowband reference signals via RRC signaling, dynamic control signaling (e.g., a MAC-CE or DCI message that indicates that the UE is to activate the SCell), or both. For instance, the RRC signaling may indicate candidate time resources, frequency resources, or both, for the narrowband reference signals, and the control message may indicate one of the candidate sets of resources. In some examples, the RRC signaling may indicate some resources information (e.g., frequency domain resources) and the control message may indicate a remainder of resource information (e.g., time resources, or both time resources and one of a set of configured candidate frequency resources). In some examples, the control message may include an indication of both time and frequency resources for the narrowband reference signals. The time and frequency resources of the narrowband reference signals may include a subchannel of a bandwidth of the SCell (e.g., the resources allocated for the dynamic narrowband reference signals on the SCell may be contiguous or noncontiguous, and may span a frequency range or set of frequency ranges that is less than (e.g., does not span) an entire band or bandwidth of the SCell).

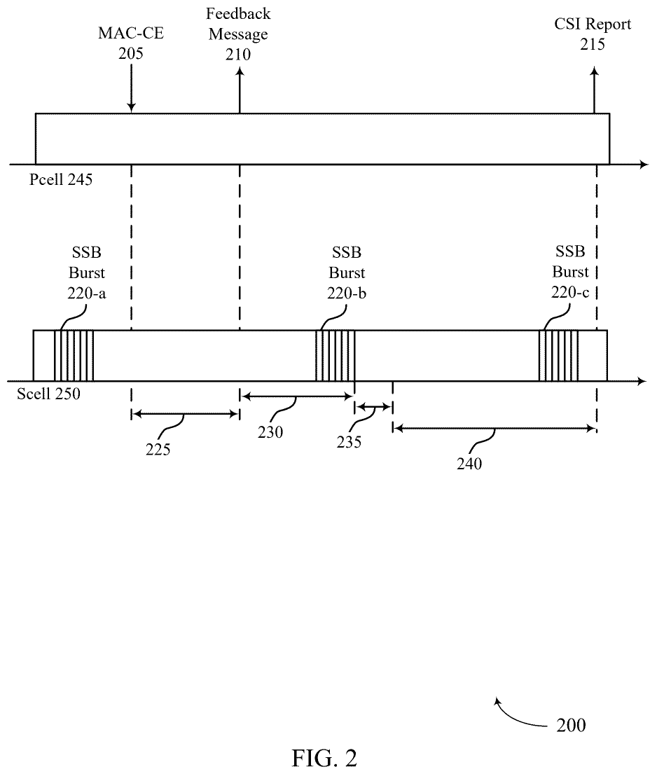

FIG. 2 shows an example of a timeline 200 that supports dedicated reference signaling for cell activation in accordance with one or more aspects of the present disclosure. The timeline 200 may implement, or be implemented by, aspects of the wireless communications system 100. For example, a UE and a network entity (e.g., which may be examples of corresponding devices described with reference to FIG. 1) may communicate with each other in accordance with the timeline 200.

The wireless communication system may support carrier aggregation and configuration of SCells. The accessibility of SCells with low latency (e.g., SCells can be activated without extended delays and increased latency), without significantly increasing UE power consumption, may result in increased throughput for the wireless communications system. For instance, power saving may be achieved by keeping all SCells in a deactivated state, but that would result in a significant delay and decrease in throughput, negating the benefits of carrier aggregation.

Cells may be activated according to one or more techniques. For example, a wireless communications system may support direct activation of SCells upon RRC configuration of the cells (e.g., the RRC signaling configuring the SCells also indicates an active, or deactivate, state for the SCells). Some wireless communications systems may support activation or deactivation of SCells via a MAC-CE. Some SCells may be activated or deactivated (e.g., according to enhanced activation or deactivation) using a MAC-CE and one or more temporary tracking reference signals (TRSs). Some wireless communications systems may support activation of SCells via BWP s witching (e.g., a dormant BWP may refer to a BWP in which one or more SCells have been configured, but the SCells may not be considered fully activated until the BWP is activated).

SCell activation (e.g., and a timing of the SCell activation) may depend on one or more factors or parameters, which may include a frequency range (FR) of a cell (e.g., FR1, FR2, etc.), whether the cell is classified (e.g., or defined) as a known SCell or an unknown SCell (e.g., which may be defined for FR1 and FR2), a reporting period and measurement cycle, an activation mechanism, whether the activated SCell is the PCell of a secondary physical uplink control channel (PUCCH) group, whether the activated SCell corresponds to a different timing advance group (TAG), scheduling inefficiencies (e.g., waiting for multiple rounds of CSI reporting before scheduling or a type of CSI-RS report selected in some deployments), or any combination thereof. Any of these factors and parameters, or others, may result in delays in activation of an SCell. Further, in some examples, a UE may initiate or suspend one or more operations upon activation of an SCell (e.g., via MAC-CE activation).

Known cells and unknown cells may be defined with reference to FR1 according to one or more known SCell conditions. For example, an SCell may be considered known if, during a period equal to the greater of a set of measurement cycles at the SCell (meascycleSCell) and a set of discontinuous reception (DRX) cycles (e.g., max(5*measCycleSCell, 5*DRX cycles) for FR1 before reception of an SCell activation command, the UE sends a valid measurement report (e.g., a measurement report via valid uplink or flexible slots or symbols) for the SCell being activated, the SSB measured remains detectable according to one or more cell identification conditions, or both. The SSB measured during the period may also remain detectable during the SCell activation delay according to the cell identification conditions. If such conditions are satisfied, then the Cell may be referred to as a known SCell.

Known cells and unknown cells may also be defined with reference to FR2. A cell may be known if during a period equal to 4s for UE power class 1 and 3s for UEs supporting power class 2, 3, or 4, before the UE receives a lats activation command for physical downlink control channel (PDCCH), transmission configuration indicator (TCI) state, physical downlink shared channel (PDSCH) TCI, and semi-persistent CSI-RS for channel quality information (CQI) reporting, the UE has sent a valid layer 3(L 3 ) reference signal receive power (RSRP) measurement report with an SSB index, the SCell activation command is received after the L3-RSRP reporting and no longer than the time when the UE receives the MAC-CE command for TCI activation, or both. During the period for the L3-RSRP reporting to the next valid CQI reporting, the reported SSBs with indices may remain detectable according to cell identification conditions, and the TCI state may be selected based on one of the latest reported SSB indices. If such conditions are satisfied, then the Cell may be referred to as a known SCell.

In some examples, delays in SCell activation may result in increased system latency and decreased throughput. For example, measurement, time alignment, and other operations associated with activating an SCell may increase a wait time for automatic gain control (AGC) and synchronization derivation. For instance, the UE may perform wireless communications via a PCell 245. The network may activate an SCell 250. The SCell 250 may correspond to FR1, with a measurement period of, for example, less than 2400 ms.

The UE may receive a control message (e.g., a MAC-CE 205) for SCell activation of the SCell 250 (e.g., the MAC-CE 205 may include an SCell activation and a TCI activation). The MAC-CE 205 may be received via a first slot (e.g., slot n). The UE may take some threshold processing time (e.g., the time duration 225, which may be referred to as T_{HARQ}) to process the MAC-CE, after which the UE may transmit a feedback message 210 (e.g., a HARQ acknowledgement (ACK) message) indicating receipt of the MAC-CE 205. Although the UE may be capable of performing timing synchronization for the SCell after the time duration 225, the UE may not be able to do so until a next SSB burst 220 occurs. For instance, the SSB bursts 220 may be periodic (e.g., occurring ever 20 ms, or sparser). The SSB burst 220-a may have already occurred prior to the expiration of the time duration 225. The UE may have to wait for at least a delay time duration 230 (e.g., until a next available SSB burst 220-b) to perform synchronization (e.g., fine time and frequency synchronization). The time duration 230 may be an amount of time during which the UE waits to collect a first available SSB sample, which could be one or more multiple SSB periodicities. The time duration 230 may be referred to as T_{FirstSSB}). After the SSB burst 220-b, the UE may wait time period 235 (e.g., 2 ms) to process or perform measurements based on the received SSBs of the SSB burst 220-b. At this point, the UE may also wait for the time duration 240 until a next valid CSI report is available (e.g., at which point the UE may transmit the CSI report 215). The next valid CSI report opportunity may occur after another SSB burst 220-c. The time duration 240 may be referred to as T_{CSI_Reporting}). In some examples, the network entity may attempt to decrease the latency, but such aspects may be dependent on known or unknown status of SCells, and may therefore be inapplicable in some scenarios.

Thus, the periodic nature of the SSBs may result in increased delay (e.g., the time duration 230) in measurement and synchronization, and further delays in CSI reporting (e.g., due to the time duration 240). If SSB periodicity is sparser, which may be supported in some wireless communications systems, then latency of SCell activation may be further increased. Although the UE may be ready and able to perform synchronization and activation of the SCell (e.g., as early as upon expiration of the time duration 225), the UE may be limited in its capacity to quickly and efficiently activate the SCell by the fixed timing of the SSB bursts 220.

According to techniques described herein, the network may dynamically configure and transmit reference signals (e.g., narrowband reference signals via a subchannel of the to-be-activated SCell 250) which the UE can use to perform measurements and operations resulting in low latency and low power expenditure activation of the SCell 250. In some examples, the UE may utilize some aspects or apparatuses (e.g., hardware) utilized for SSB processing to perform such measurements and operations for SCell activation, without the same delays that result from SSB processing. In some examples, such techniques may be applied to all cells (e.g., known and unknown SCells), or may be utilized under specific situations (e.g., depending on a known or unknown status of the to-be-activated SCell, a frequency range (e.g., FR1 or FR2) of the to-be-activated SCell, or the like).

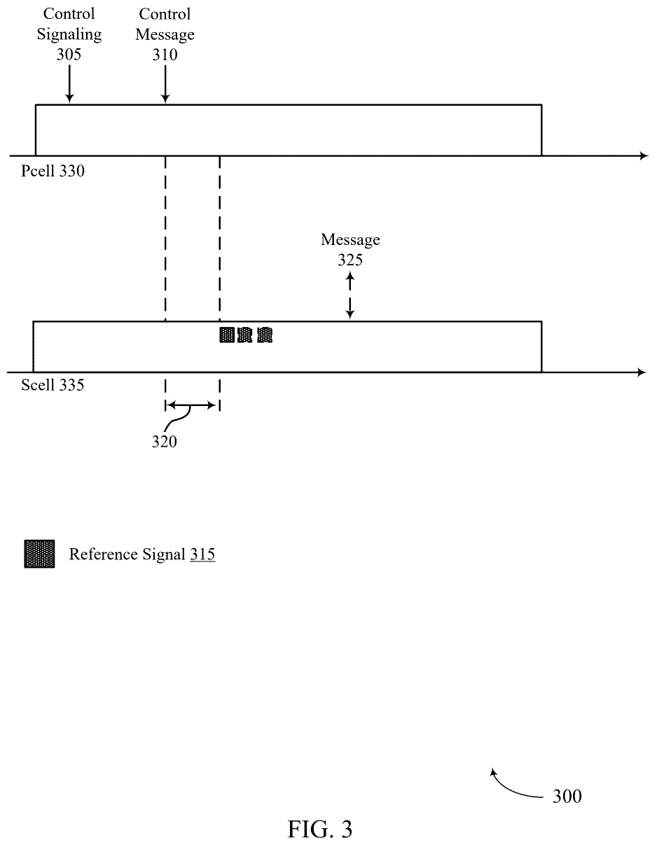

In some examples, as described in greater detail with reference to FIGS. 2-3, the network entity may transmit a control message (e.g., a control message including an instruction to activate an SCell, such as the MAC-CE 205) which may include an indication of one or more aperiodic narrowband reference signals for SCell activation. The UE may monitor for and receive the narrowband reference signals based on the dynamic control signaling indicating the narrowband reference signals (e.g., instead of waiting for a next SSB burst 220 to perform timing acquisition and synchronization, etc.). The reference signals may include PSSs, SSSs, or the like. The network may indicate the resources for the narrowband reference signals via RRC signaling, dynamic control signaling (e.g., a MAC-CE or DCI message that indicates that the UE is to activate the SCell), or both. For instance, the RRC signaling may indicate candidate time resources, frequency resources, or both, for the narrowband reference signals, and the control message may indicate one of the candidate sets of resources. In some examples, the RRC signaling may indicate some resources information (e.g., frequency domain resources) and the control message may indicate a remainder of resource information (e.g., time resources, or both time resources and one of a set of configured candidate frequency resources). In some examples, the control message may include an indication of both time and frequency resources for the narrowband reference signals. The time and frequency resources of the narrowband reference signals may include a subchannel of a bandwidth of the SCell (e.g., the resources allocated for the dynamic narrowband reference signals on the SCell may be contiguous or noncontiguous, and may span a frequency range or set of frequency ranges that is less than (e.g., does not span) an entire band or bandwidth of the SCell).

FIG. 3 shows an example of a timeline 300 that supports dedicated reference signaling for cell activation in accordance with one or more aspects of the present disclosure. The timeline 300 may implement, or be implemented by, aspects of the wireless communications system 100, and the timeline 200. For example, a UE and a network entity (e.g., which may be examples of corresponding devices described with reference to FIGS. 1-2) may perform wireless communications in accordance with the timeline 300.

The UE may be configured (e.g., via control signaling 305, such as RRC signaling) with a PCell 330 and one or more SCells (e.g., including the SCell 335). For SCell activation (e.g., activation of the SCell 335), the network entity may dynamically indicate reference signals 315 to the UE 115. The reference signals 315 may be similar to or identical to PSSs and SSSs, but may be independent from the SSB configuration on the to-be-activated SCell. For example, the control signaling 305 (e.g., or other control signaling) may indicate an SSB configuration (e.g., including a periodicity for the SSBs). However, the reference signals 315 (e.g., aperiodic narrowband reference signals) may be independent from and different from the SSBs. The reference signals 315 may be configured with different parameter values than SSBs. For instance, the SSBs and the reference signals 315 may have different periodicities or timing, different quantities of beams per burst, different gaps between beams (e.g., or beam identifiers), different SSB-based measurement timing configurations (SMTCs), or any combination thereof. For instance, the reference signals 315 may be narrowband reference signals located on a subchannel of the SCell 335 (e.g., the frequency resources of the one or more reference signals 315 may be less than an available bandwidth of the SCell 335). The reference signals 315 may not be located at an SSB raster point that lies within the SCell.

The UE may perform measurements, time synchronization, fine time and frequency alignment, or the like, based on the reference signals 315. Based on having received the reference signals, the UE may communicate messages 325 via the SCell. In some examples, the UE may report a message 325 (e.g., a report message) indicating channel state information, or the like, based on receiving (e.g., and performing one or more measurements) on the reference signals 315.

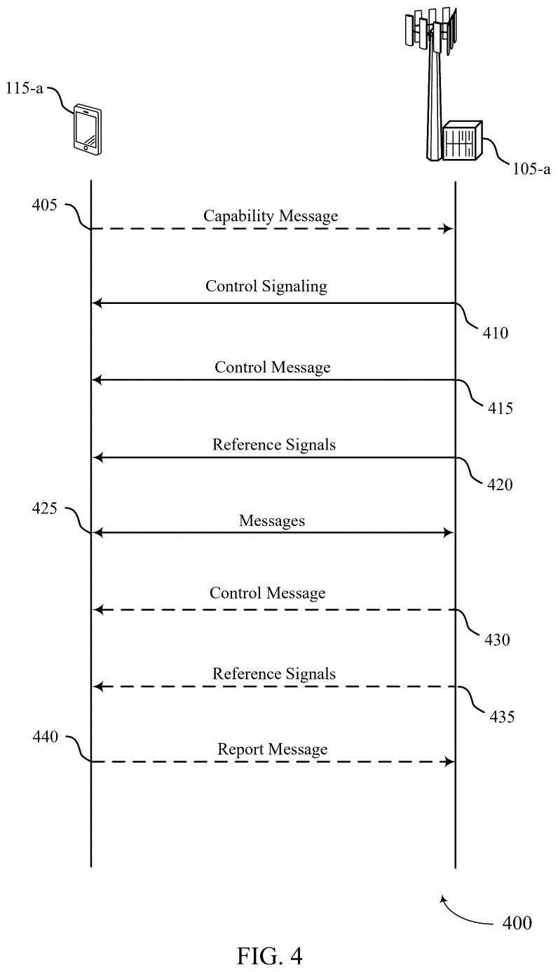

The dynamic indication of the reference signals 315 may be performed via a control message 310 (e.g., a PDCCH message, such as a DCI message, or a MAC-CE). In some examples, the control message 310 may include both an indication (e.g., a command) to activate the SCell 335, and an indication of the reference signal 315. The control signaling 305, the control message 310, or a combination thereof, may indicate the time resources and the frequency resources of the reference signals 315 (e.g., as described in greater detail with reference to FIG. 4). In some examples, the network may dynamically indicate resources for a single reference signal. In some examples, the network may dynamically indicate resources for multiple reference signals.

In some cases, where one or multiple reference signal instances per beam is to be utilized (e.g., to acquire coarse and fine AGC on an unknown SCell 335), PDCCH or MAC-CE (e.g., the control message 310) may give frequency domain and time domain information of a first instance of the reference signal 315. A remainder of instances of the reference signal 315 may be implicitly indicated with reference to the first instance of the reference signal 315. For example, frequency domain information may be given for the first reference signal 315, and the same frequency domain information may be used (e.g., may apply) to all other reference signals 315 (e.g., the multiple reference signals 315 may be transmitted via the same frequency resources but different time resources). In some examples, the time domain information may be given for a first instance of the reference signal 315, which may be used by the UE to derive the time domain resources of other instances of the reference signal 315 (e.g., valid subsequent symbols may be utilized, where a valid symbol may be defined as being located in a downlink slot or flexible slot, as not overlapping with any SSB symbols in the same or other cell, or a combination thereof, among other examples). A quantity of reference signals may be allocated per valid slot, and a predefined symbol gap between reference signals 315 in each slot may be defined or assumed. In some examples, the resources for the reference signals 315 may be determined (e.g., by the UE) based on a first instance of the reference signals 315 and a predefined pattern (e.g., which may be defined in one or more standards documents or indicated via control signaling). In some examples, such patterns may be repeated for a defined quantity of times, in accordance with a defined periodicity, or both (e.g., where the quantity of repeats and periodicity of the pattern are defined in one or more standards documents or indicated via control signaling).

A reference signal block for SCell activation may be similar to (e.g., include the same contents or structure as) an SSB, or may contain aspects similar to the SSB. For instance, a reference signal block including the refence signals 315 may include a PSSs, SSSs, and a physical broadcast channel (PBCH). In some examples, the reference signal block may include PSSs and SSSs (e.g., but no PBCH). In case PSSs and SSSs, or similar sequences, or utilized for the reference signal 315, are utilized, the locations of the reference signals 315 within the reference signal block may be the same as the locations of corresponding PSSs and SSSs in an SSB, or may be different than the locations of corresponding PSSs and SSSs in an SSB. For example, the PSSs and SSSs may be contiguous (e.g., back-to-back in time), or there may be a gap between the PSSs and SSSs of a reference signal block. In some examples, a reference signal block including the reference signals 315 may be formed using one or more sequences, which may be similar to (e.g., but not the same as) PSSs and SSSs of an SSB configuration. For instance, the reference signals 315 may be formed according to a Zadoff-Chu (ZC) sequence, and m-sequence, a Gold sequence, or the like (e.g., but using different parameters from the SSB). For example, a quantity of sequences forming the reference signals 315 may be different than a quantity of sequences forming the SSBs, an initial setting of parameters to generate the sequences may be different, or the like. For instance, a cell identifier of the SCell may be used to generate a sequence, or another parameter indicated by the network entity may be used. In some examples, sequence generation (e.g., for the reference signals 315) may be dependent on a symbol or slot index.

In some examples, a quantity of resource blocks (RBs) and symbols for the reference signals 315 (e.g., PSSs and SSSs) may be the same as a quantity of RBs and symbols used for corresponding sequences in an SSB (e.g., or may be different than the quantity of RBs and symbols used for corresponding sequences in an SSB). In some examples, the reference signal block for the reference signals 315 may only include one type of sequence, such as an SSS or similar sequence.

In some examples, the network may configure the contents of the reference signal block for the reference signals 315 (e.g., the network may configure, via control signaling 305 or the control message 310, whether the reference signal block includes both PSSs and SSSs, or whether only one type of sequence (e.g., SSSs) is included in the reference signal block). The contents or makeup of the reference signal block for the reference signals 315 may be dependent on how accurate time and frequency synchronization is on a given cell, how often SSB measurements are performed, an SSB periodicity, an SMTC configuration, how often measurements are reported, or whether there is at least one other cell that is already activated in the same band as the to-be-activated SCell, among other examples. In cases where both PSSs and SSSs (e.g., or similar sequences) are utilized, or where only one type of sequence (e.g., SSSs) are used, the sequence indices may be indicated to the UE (e.g., via the control signaling 305, the control message 310, another control message, or any combination thereof). Such indications of what types of sequences or signals are included in the dynamic reference signal block, or indications of a sequence index, may reduce the burden of searching and performing multiple hypotheses at the UE. For example, if the UE is aware of a sequence index for the sequences to be utilized in the reference signals 315 (e.g., if the network entity indicates a sequence index of a set of candidate sequence indices for the reference signals 315), then the UE may not waste time and power checking and performing hypothesis testing for other candidate sequences, and may more quickly receive and decode the reference signals 315.

In some examples, dedicated reference signals 315 for SCell activation may be applied to all scenarios, or application of the dedicated reference signals 315 for SCell activation may be restricted to certain scenarios or conditions. For example, dedicated reference signals 315 for SCell activation may be applicable for only known cells, unknown cells, or both. In some examples, dedicated reference signals 315 for SCell activation may be applicable to unknown cells only before a TCI activation command is received (e.g., for purposes of course and fine AGC setting in between MAC-CE activation without TCI indications up to the time of TCI activation command reception). In some examples, dedicated reference signals 315 for SCell activation may be applicable for some FRs, bands, or frequency resources, but may be inapplicable in others. In some examples, dedicated reference signals 315 for SCell activation may be applicable across all FRs, bands, and frequency resources. The conditions or scenarios in which dedicated reference signals 315 for SCell activation are applicable may be defined in one or more standards documents, or may indicated via control signaling.

In case of activating a single SCell or multiple intra-band SCells simultaneously via the RSs 315, time allocation of such reference signals 315 across all intra-band component carriers (e.g., including both activated cells as well as to-be-activated cells) may follow one or more rules. For example, reference signal occasions (e.g., slots or symbols for SSBs) of already activated cells may not be required to be aligned (e.g., across component carriers). In some examples, the network entity may transmit an explicit indication of whether reference signal occasions (e.g., SSBs on active cells and reference signals 315 on to-be-activated SCells 335) are permitted to be misaligned or are to be aligned. For example, if a large quantity of cells are already activated, then interruption of downlink traffic may be costly. In such cases, alignment across component carriers or cells may be preferred. Otherwise, non-aligned patterns may be used. When patterns of reference signals are not aligned (e.g., across component carriers or cells), interruptions may be permitted or supported (e.g., the UE may decode downlink signaling as a best effort, or may cancel or avoid processing downlink signaling on other cells). In some examples, reference signal occasions for the reference signals 315 of to-be-activated cells that are to be activated simultaneously may not be aligned.

In some examples, before receiving the activation command (e.g., the control message 310), the UE may be performing measurements via SSBs. After receiving the activation command, the UE may rely on the triggered reference signals 315 for activation of the SCell 335. During the transition, there may be cases in which the UE is to retune (e.g., retune from radio frequencies corresponding to the SSBs to radio frequencies corresponding to the reference signals 315) from monitoring SSBs to monitoring triggered reference signals 315. However, if a time gap between the SSBs and the reference signals 315 is not sufficiently long, then the UE may not be able to successfully receive the reference signals 315 (e.g., based on the retuning). For example, the UE may prepare to monitor an SSB burst, or may already be monitoring an SSB burst when the UE receives the activation command (e.g., the control message 310) indicating that the UE is to switch to monitoring the reference signals 315, which may occur immediately (e.g., or shortly) after the reception of the control message 310. To avoid failure to receive the reference signals 315, the reference signals 315 may be transmitted after a threshold time gap 320 after transmission of the control message 310.

The threshold time gap 320 may be defined as a quantity of symbols or a specific amount of time. The threshold time gap 320 may occur between the first instance of the SCell activation reference signals and the control message 310, and may accommodate a threshold amount of time between a first instance of the SCell activation reference signals 315 (e.g., the first symbol after processing the activation command) and the last SSB occasion before processing the activation command. In the case of MAC-CE based activation, processing of the activation command may be considered complete at the lats symbol of a PUCCH carrying the HARQ-ACK associated with the PDSCH carrying the MAC-CE command. In case of PDCCH (e.g., DCI) based activation, the processing of the activation command may be considered complete at a last symbol of PDCCH or the control resource set (CORESET) in which the PDCCH was decoded. The value of the threshold time gap 320 may be defined in the specification, or may be based on UE capability (e.g., the UE may transmit capability information indicating a threshold processing time or time gap after which the UE is capable of receiving the reference signals 315 after processing the activation command). In some examples, the duration of the threshold time gap 320 may be further dependent on a band of operation, a frequency range, a subcarrier spacing (SCS), or the like.

In some examples, different types of reference signals 315 for SCell activation may be defined (e.g., wideband reference signals, and narrowband reference signals, SSBs, PSSs, SSSs, or similar sequences). In some examples, wideband reference signals may be supported for known cells (e.g., or in some specific known scenarios defined in one or more standards documents), and narrowband reference signals may be used for SCell activation in unknown cells. In some examples, a single type or structure of reference signals 315 may be defined (e.g., aperiodic narrowband reference signals 315) which may be used for unknown cells if one or more conditions are satisfied. For example, use of narrowband reference signals 315 may be utilized for SCell activation based on how accurate AGC is (e.g., how frequently the UE is performing measurements before receiving the activation command), how accurate time and frequency synchronization is, based on whether there is at least one other activated cell in the same band as the to-be-activated SCell, or the like. In some cases, categories or sub-categories of unknown cells or known cells may be defined, and application of dynamic narrowband reference signals 315 for SCell activation may be applicable or supported based on whether the to-be-activated cell satisfies one or more conditions or falls into one of the sub-categories of unknown cells.

In some examples, the UE may transmit capability information indicating whether the UE supports dynamic reference signals 315 for SCell activation. The UE may report such capability on a per UE basis, a per band basis, a per fixed service (FS) basis, a per subband channel or subchannel basis, a per band combination basis, a per band of a band combination (BoBC) basis, or the like. In some examples, a wireless communications system may support capability for all devices (e.g., a mandatory capability) to use the reference signals 315 for SCell activation.

In some examples, the network may trigger the reference signals 315 for deactivated SCell measurements. The trigger may be independent from the SCell activation command (e.g., the control message 310). Such cells may support always-on SSBs, or may not support always on SSBs. The trigger may be a distinct control message (e.g., different from the control message 310), such as a MAC-CE, RRC message, or DCI message, or a combination thereof. The network may trigger the reference signals 315 for measurements on a deactivated or inactive SCell, and the UE may perform measurements and report measurements on the deactivated SCell. The UE may transmit a messages (e.g., a message 325) including a measurement report for the deactivated SCell based on receiving the reference signals 315 via the deactivated SCell.

In some examples, if the network entity determines to activate an SCell, the network may transmit a first control message 310 indicating activation of the SCell, and a second control message 310 indicating the reference signals 315. The two control messages may be sent together (e.g., via a single signal) or separately (e.g., via two PDCCH messages, via two MAC-CEs, or via a PDCCH message for one control message 310 and via a MAC-CE for the other control message 310.

FIG. 4 shows an example of a process flow 400 that supports dedicated reference signaling for cell activation in accordance with one or more aspects of the present disclosure. The process flow 400 may implement, or be implemented by, aspects of the wireless communications system 100, the timeline 200, and the timeline 300. For example, the process flow 400 may include a UE 115-a and a network entity 105-a, which may be examples of corresponding devices described with reference to FIGS. 1-3.

At 410, the UE 115-a may receive control signaling (e.g., from the network entity 105-a). The control signaling may be RRC signaling. The control signaling may indicate a PCell and one or more SCells. In some examples, the control signaling (e.g., or other control signaling) may configure periodic SSB bursts (e.g., on the PCell, the one or more SCells, or both).

At 415, the UE 115- a may receive (e.g., from the network entity 105-a) a control message (e.g., such as a MAC-CE or DCI via a PDCCH). The control message may indicate activation of an SCell of the one or more SCells. The control message may include an indication of a set of aperiodic narrowband reference signals (e.g., such as the reference signals 315) for a subchannel (e.g., a portion of the frequency resources) of the SCell. For example, the aperiodic narrowband reference signals may span less frequency resources than a total available frequency range or band of the SCell.

The network entity 105-a may indicate time domain and frequency domain allocation of resources for the reference signals via the control signaling at 410, the control message at 415, or a combination thereof. For example, the network may configure multiple candidate time and frequency resources (e.g., via the control signaling, such as RRC signaling). The control message (e.g., the MAC-CE or DCI) may indicate one of the set of configured time and frequency resources sets for the triggered narrowband reference signals. In some examples, the control signaling (e.g., RRC signaling) may indicate candidate sets frequency domain resources, and the control message may indicate time domain resources as well as one of the candidate frequency domain resource sets for the aperiodic narrowband reference signals. In some examples, the DCI or MAC-CE message (e.g., the control message received at 415) may include a frequency domain resource allocation and a time domain resource allocation for time and frequency resources for the aperiodic narrowband reference signals.

In some examples, time domain information may be indicated (e.g., to the UE 115-a via the control signaling, the control message, or both) as an offset from the end of a PDCCH carrying the activation command or an offset from the end of a PUCCH carrying the HARQ-ACK for the received MAC-CE. In some examples, the frequency domain information may be indicated (e.g., to the UE 115-a via the control signaling, the control message, or both) as an offset from the CD-SSB on the to-be-activated SCell (e.g., from a raster point on which the SSB is actually transmitted). IN some cases, the frequency domain information may be indicated with respect to RBs within the component carrier or any of the configured BWPs (e.g., with reference to a configured firstActiveDownlinkBWP-ID).

In some examples, the UE 115-a may receive (e.g., via the control signaling, the control message, or both) an indication of time and frequency resources for a first reference signal of the set of narrowband reference signals. The UE may determine a remainder of the set of aperiodic narrowband reference signals based on the indication of the time and frequency resources of the first aperiodic narrowband reference signal (e.g., according to an indicated patter, one or more rules, or the like).

At 420, the UE 115-a may receive the aperiodic narrowband reference signals via the subchannel of the secondary cell in accordance with the control message. Each aperiodic narrowband reference signal of the set of aperiodic narrowband reference signals may include one or more PSSs, SSSs, a PBC, sequences similar to the PSSs and SSSs, only PSSs and SSSs, only SSSs, or any combination thereof. In some examples, occasions of the SSBs on active cells may or may not be aligned with the narrowband reference signals on the to-be-activated SCell. In some examples, the reference signals may be received at least a threshold time offset after reception of the control message, or a most recent SSB prior to receiving the control message, or both. In some examples, at 405, the UE 115-a may transmit a control message indicating a time gap that is less than or equal to the threshold time offset. In such examples, the network entity 105-a may ensure that scheduling, triggering, and transmitting the reference signals 420 occur after the indicated time gap.

At 425, the UE 115-a may communicate (e.g., transmit or receive or both) one or more messages via the secondary cell in accordance with the one or more measurements of the set of aperiodic narrowband reference signals received at 420.

In some examples, the UE 115-a may transmit a capability message (e.g., at 405) indicating that the UE supports dynamic activation of the one or more SCells, and receiving the control message at 415 may be based at least in part on the capability message transmitted at 405. In some examples, the UE 115-a may transmit a capability that is dependent on a quantity of component carriers. For example, the UE 115-a may indicate, in the capability message, a quantity of component carriers that the UE 115-a is capable of supporting in a given band of a band combination, or a quantity of component carriers that can be activated simultaneously, among other examples.

In some examples, the network entity 105-a may trigger additional narrowband reference signals for deactivated SCell measurements. The trigger may be independent from SCell activation command. For example, the UE 115-a may receive a second control message (e.g., a DCI or MAC-CE message that is different from or independent from the control message 415). The control message 430 may indicate a second set of aperiodic narrowband reference signals for a subchannel of an additional (e.g., deactivated or inactive) SCell. The UE 115-a may receive the second set of aperiodic narrowband reference signals via the subchannel of the additional SCell in accordance with the second control message at 435. The UE 115-a may perform one or more measurements, and may transmit a report message at 440 indicating the measurements of the deactivated SCell.

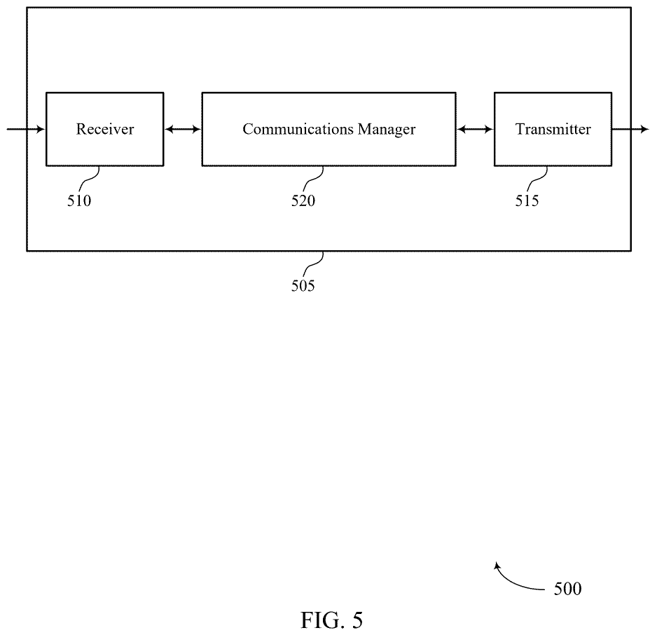

FIG. 5 shows a block diagram 500 of a device 505 that supports dedicated reference signaling for cell activation in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to dedicated reference signaling for cell activation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to dedicated reference signaling for cell activation). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of dedicated reference signaling for cell activation as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving control signaling indicating a primary cell and one or more secondary cells. The communications manager 520 is capable of, configured to, or operable to support a means for receiving a control message indicating activation of a secondary cell of the one or more secondary cells, the control message including an indication of a set of aperiodic narrowband reference signals for a subchannel of the secondary cell. The communications manager 520 is capable of, configured to, or operable to support a means for receiving the set of aperiodic narrowband reference signals via the subchannel of the secondary cell in accordance with the control message. The communications manager 520 is capable of, configured to, or operable to support a means for communicating one or more messages via the secondary cell in accordance with one or more measurements of the set of aperiodic narrowband reference signals.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for SCell activation based on dynamic narrowband reference signal, resulting in reduced processing and reduced power consumption, increased throughput, more efficient utilization of communication resources, and decreased system latency.

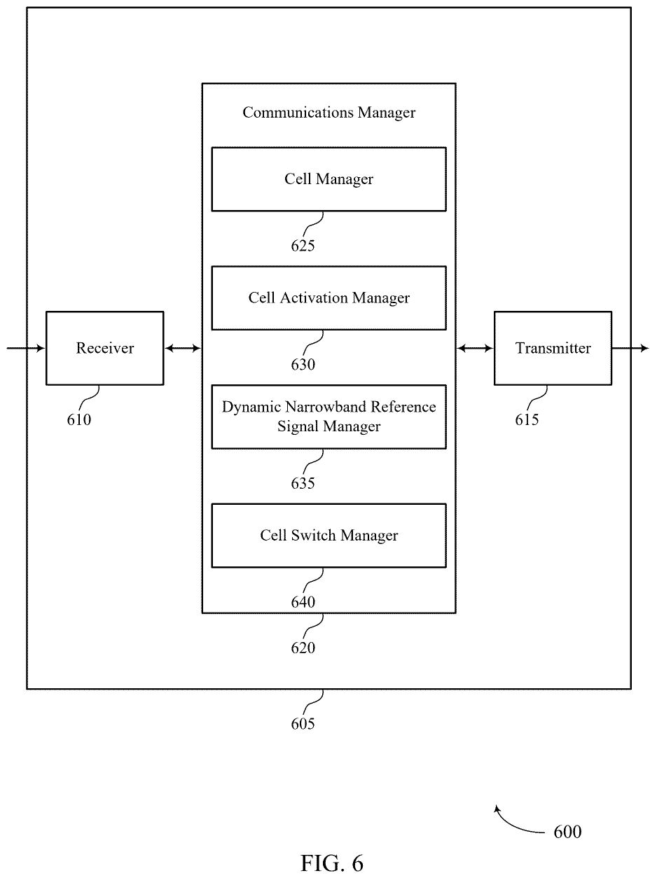

FIG. 6 shows a block diagram 600 of a device 605 that supports dedicated reference signaling for cell activation in accordance with one or more aspects of the present disclosure. The device 605 may be an example of aspects of a device 505 or a UE 115 as described herein. The device 605 may include a receiver 610, a transmitter 615, and a communications manager 620. The device 605, or one of more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to dedicated reference signaling for cell activation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to dedicated reference signaling for cell activation). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of dedicated reference signaling for cell activation as described herein. For example, the communications manager 620 may include a cell manager 625, a cell activation manager 630, a dynamic narrowband reference signal manager 635, a cell switch manager 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The cell manager 625 is capable of, configured to, or operable to support a means for receiving control signaling indicating a primary cell and one or more secondary cells. The cell activation manager 630 is capable of, configured to, or operable to support a means for receiving a control message indicating activation of a secondary cell of the one or more secondary cells, the control message including an indication of a set of aperiodic narrowband reference signals for a subchannel of the secondary cell. The dynamic narrowband reference signal manager 635 is capable of, configured to, or operable to support a means for receiving the set of aperiodic narrowband reference signals via the subchannel of the secondary cell in accordance with the control message. The cell switch manager 640 is capable of, configured to, or operable to support a means for communicating one or more messages via the secondary cell in accordance with one or more measurements of the set of aperiodic narrowband reference signals.

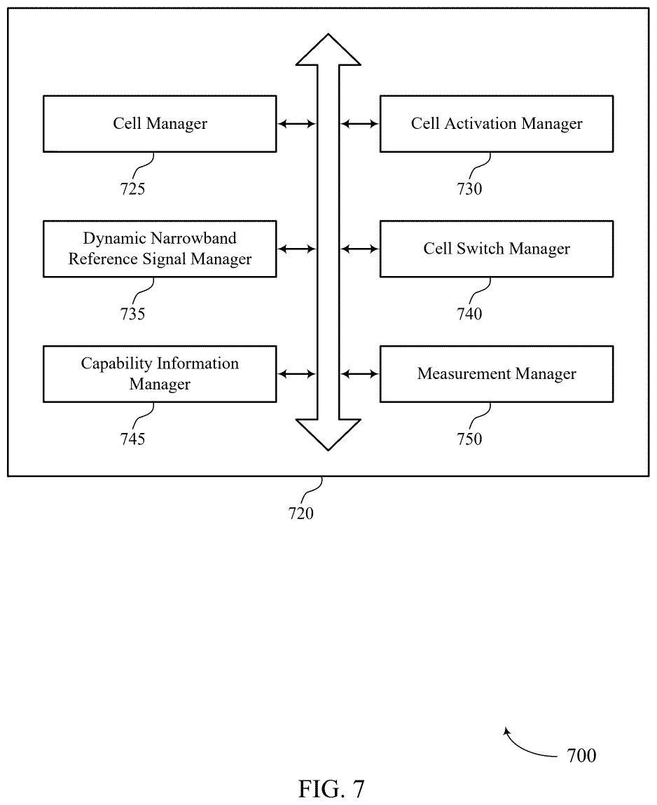

FIG. 7 shows a block diagram 700 of a communications manager 720 that supports dedicated reference signaling for cell activation in accordance with one or more aspects of the present disclosure. The communications manager 720 may be an example of aspects of a communications manager 520, a communications manager 620, or both, as described herein. The communications manager 720, or various components thereof, may be an example of means for performing various aspects of dedicated reference signaling for cell activation as described herein. For example, the communications manager 720 may include a cell manager 725, a cell activation manager 730, a dynamic narrowband reference signal manager 735, a cell switch manager 740, a capability information manager 745, a measurement manager 750, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The cell manager 725 is capable of, configured to, or operable to support a means for receiving control signaling indicating a primary cell and one or more secondary cells. The cell activation manager 730 is capable of, configured to, or operable to support a means for receiving a control message indicating activation of a secondary cell of the one or more secondary cells, the control message including an indication of a set of aperiodic narrowband reference signals for a subchannel of the secondary cell. The dynamic narrowband reference signal manager 735 is capable of, configured to, or operable to support a means for receiving the set of aperiodic narrowband reference signals via the subchannel of the secondary cell in accordance with the control message. The cell switch manager 740 is capable of, configured to, or operable to support a means for communicating one or more messages via the secondary cell in accordance with one or more measurements of the set of aperiodic narrowband reference signals.

In some examples, the dynamic narrowband reference signal manager 735 is capable of, configured to, or operable to support a means for receiving, via the control signaling, an indication of a set of candidate time and frequency resources for the set of aperiodic narrowband reference signals. In some examples, the dynamic narrowband reference signal manager 735 is capable of, configured to, or operable to support a means for receiving, via the control message, an indication of time and frequency resources of the set of candidate time and frequency resources for the subchannel of the secondary cell, where the set of aperiodic narrowband reference signals are received via the indicated time and frequency resources.

In some examples, the dynamic narrowband reference signal manager 735 is capable of, configured to, or operable to support a means for receiving, via the control signaling, an indication of a set of candidate frequency resources for the set of aperiodic narrowband reference signals. In some examples, the dynamic narrowband reference signal manager 735 is capable of, configured to, or operable to support a means for receiving, via the control message, an indication of time resources for the set of aperiodic narrowband reference signals and an indication of frequency resources of the set of candidate frequency resources for the subchannel of the secondary cell, where the set of aperiodic narrowband reference signals are received via the time and frequency resources.

In some examples, the dynamic narrowband reference signal manager 735 is capable of, configured to, or operable to support a means for receiving, via the control message, an indication of a resource allocation of time and frequency resources for the set of aperiodic narrowband reference signals, where the set of aperiodic narrowband reference signals are received via the indicated time and frequency resources.

In some examples, the dynamic narrowband reference signal manager 735 is capable of, configured to, or operable to support a means for receiving, via the control signaling, the control message, or both, an indication of time and frequency resources for receiving a first aperiodic narrowband reference signal, where time and frequency resources of a remainder of the set of aperiodic narrowband reference signals are based on the indication of the time and frequency resources for the first aperiodic narrowband reference signal.

In some examples, each aperiodic narrowband reference signal of the set of aperiodic narrowband reference signals include a primary synchronization signal, a secondary synchronization reference signal, a physical broadcast channel, or any combination thereof.

In some examples, receiving the control message including the indication of the set of aperiodic narrowband reference signals is based on the secondary cell being a known cell at the UE, the secondary cell being an unknown cell at the UE, the secondary cell being located within a first bandwidth or frequency range, a received transmission configuration indicator state at the UE, or any combination thereof.

In some examples, one or more occasions of a set of multiple SSBs and one or more occasions of the set of aperiodic narrowband reference signals do not align across a set of component carriers.

In some examples, a first aperiodic narrowband reference signal of the set of aperiodic narrowband reference signals is received at least a threshold time offset after reception of the control message.

In some examples, the capability information manager 745 is capable of, configured to, or operable to support a means for transmitting a capability message indicating that the UE supports dynamic activation of the one or more secondary cells, where receiving the control message is based on the capability message.

In some examples, the measurement manager 750 is capable of, configured to, or operable to support a means for receiving a second control message including an indication of a second set of aperiodic narrowband reference signals for a subchannel of an additional secondary cell that is deactivated. In some examples, the measurement manager 750 is capable of, configured to, or operable to support a means for receiving the second set of aperiodic narrowband reference signals via the subchannel of the additional secondary cell in accordance with the second control message. In some examples, the measurement manager 750 is capable of, configured to, or operable to support a means for transmitting a report indicating one or more measurements of the additional secondary cell based on receiving the second set of aperiodic narrowband reference signals.

In some examples, the control message includes a MAC control element (CE), or a DCI message.

In some examples, control signaling includes an indication of a set of multiple periodic synchronization signal blocks (SSBs) for at least the primary cell.

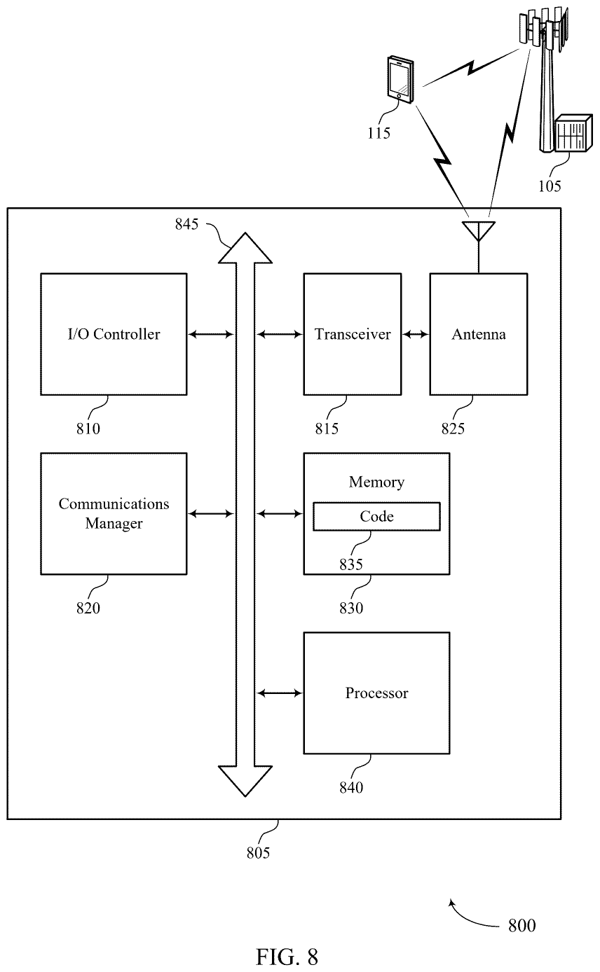

FIG. 8 shows a diagram of a system 800 including a device 805 that supports dedicated reference signaling for cell activation in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting dedicated reference signaling for cell activation). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving control signaling indicating a primary cell and one or more secondary cells. The communications manager 820 is capable of, configured to, or operable to support a means for receiving a control message indicating activation of a secondary cell of the one or more secondary cells, the control message including an indication of a set of aperiodic narrowband reference signals for a subchannel of the secondary cell. The communications manager 820 is capable of, configured to, or operable to support a means for receiving the set of aperiodic narrowband reference signals via the subchannel of the secondary cell in accordance with the control message. The communications manager 820 is capable of, configured to, or operable to support a means for communicating one or more messages via the secondary cell in accordance with one or more measurements of the set of aperiodic narrowband reference signals.

By including or configuring the communications manager 820 in accordance with examples as described herein, the device 805 may support techniques for SCell activation based on dynamic narrowband reference signal, resulting in reduced processing and reduced power consumption, increased throughput, more efficient utilization of communication resources, improved coordination between devices, longer battery life, and decreased system latency.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of dedicated reference signaling for cell activation as described herein, or the at least one processor 840 and the at least one memory 830 may be otherwise configured to, individually or collectively, perform or support such operations.

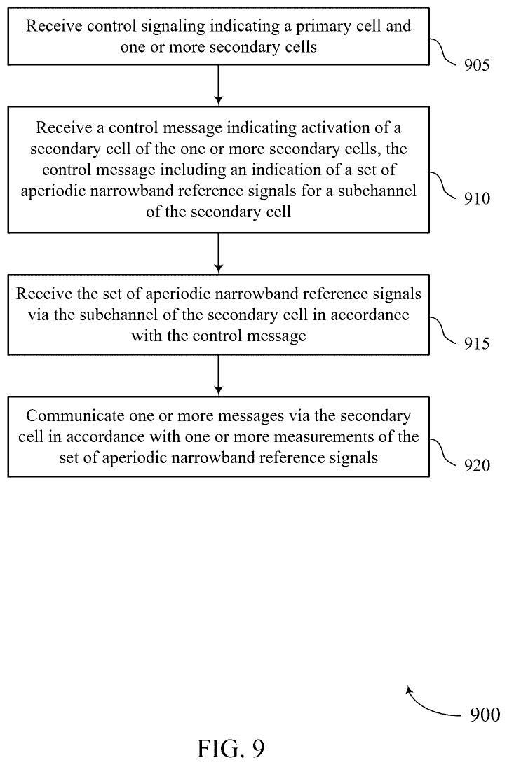

FIG. 9 shows a flowchart illustrating a method 900 that supports dedicated reference signaling for cell activation in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving control signaling indicating a primary cell and one or more secondary cells. The operations of 905 may be performed in accordance with examples as disclosed herein. In some examples, aspects of the operations of 905 may be performed by a cell manager 725 as described with reference to FIG. 7.

At 910, the method may include receiving a control message indicating activation of a secondary cell of the one or more secondary cells, the control message including an indication of a set of aperiodic narrowband reference signals for a subchannel of the secondary cell. The operations of 910 may be performed in accordance with examples as disclosed herein. In some examples, aspects of the operations of 910 may be performed by a cell activation manager 730 as described with reference to FIG. 7.

At 915, the method may include receiving the set of aperiodic narrowband reference signals via the subchannel of the secondary cell in accordance with the control message. The operations of 915 may be performed in accordance with examples as disclosed herein. In some examples, aspects of the operations of 915 may be performed by a dynamic narrowband reference signal manager 735 as described with reference to FIG. 7.

At 920, the method may include communicating one or more messages via the secondary cell in accordance with one or more measurements of the set of aperiodic narrowband reference signals. The operations of 920 may be performed in accordance with examples as disclosed herein. In some examples, aspects of the operations of 920 may be performed by a cell switch manager 740 as described with reference to FIG. 7.

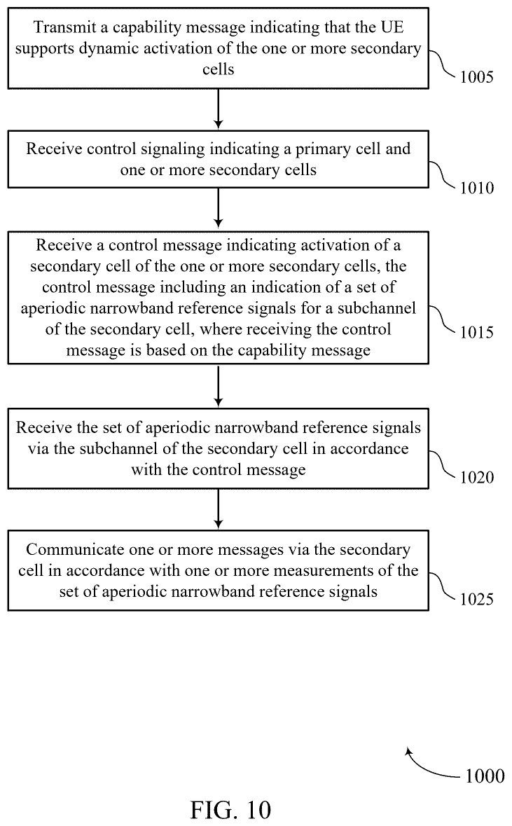

FIG. 10 shows a flowchart illustrating a method 1000 that supports dedicated reference signaling for cell activation in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include transmitting a capability message indicating that the UE supports dynamic activation of the one or more secondary cells. The operations of 1005 may be performed in accordance with examples as disclosed herein. In some examples, aspects of the operations of 1005 may be performed by a capability information manager 745 as described with reference to FIG. 7.

At 1010, the method may include receiving control signaling indicating a primary cell and one or more secondary cells. The operations of 1010 may be performed in accordance with examples as disclosed herein. In some examples, aspects of the operations of 1010 may be performed by a cell manager 725 as described with reference to FIG. 7.

At 1015, the method may include receiving a control message indicating activation of a secondary cell of the one or more secondary cells, the control message including an indication of a set of aperiodic narrowband reference signals for a subchannel of the secondary cell, where receiving the control message is based on the capability message. The operations of 1015 may be performed in accordance with examples as disclosed herein. In some examples, aspects of the operations of 1015 may be performed by a cell activation manager 730 as described with reference to FIG. 7.

At 1020, the method may include receiving the set of aperiodic narrowband reference signals via the subchannel of the secondary cell in accordance with the control message. The operations of 1020 may be performed in accordance with examples as disclosed herein. In some examples, aspects of the operations of 1020 may be performed by a dynamic narrowband reference signal manager 735 as described with reference to FIG. 7.

At 1025, the method may include communicating one or more messages via the secondary cell in accordance with one or more measurements of the set of aperiodic narrowband reference signals. The operations of 1025 may be performed in accordance with examples as disclosed herein. In some examples, aspects of the operations of 1025 may be performed by a cell switch manager 740 as described with reference to FIG. 7.

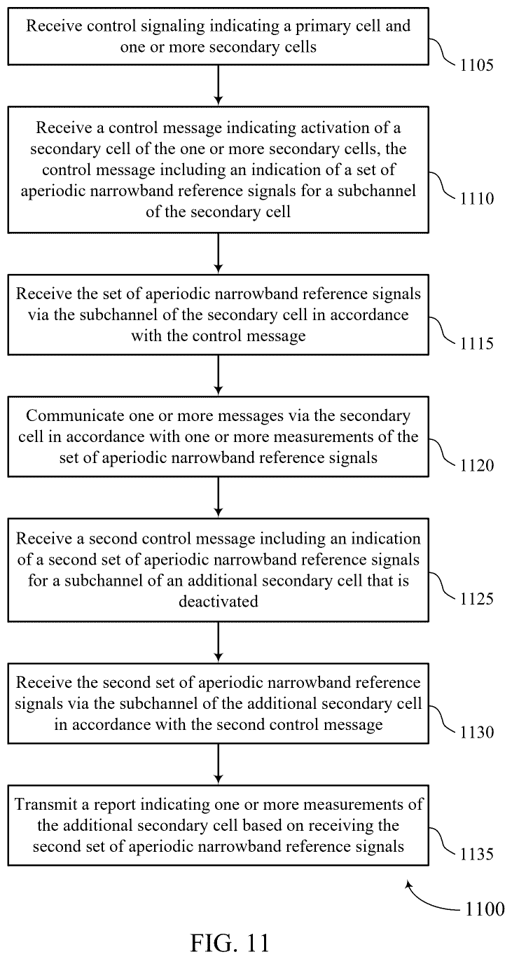

FIG. 11 shows a flowchart illustrating a method 1100 that supports dedicated reference signaling for cell activation in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include receiving control signaling indicating a primary cell and one or more secondary cells. The operations of 1105 may be performed in accordance with examples as disclosed herein. In some examples, aspects of the operations of 1105 may be performed by a cell manager 725 as described with reference to FIG. 7.

At 1110, the method may include receiving a control message indicating activation of a secondary cell of the one or more secondary cells, the control message including an indication of a set of aperiodic narrowband reference signals for a subchannel of the secondary cell. The operations of 1110 may be performed in accordance with examples as disclosed herein. In some examples, aspects of the operations of 1110 may be performed by a cell activation manager 730 as described with reference to FIG. 7.

At 1115, the method may include receiving the set of aperiodic narrowband reference signals via the subchannel of the secondary cell in accordance with the control message. The operations of 1115 may be performed in accordance with examples as disclosed herein. In some examples, aspects of the operations of 1115 may be performed by a dynamic narrowband reference signal manager 735 as described with reference to FIG. 7.

At 1120, the method may include communicating one or more messages via the secondary cell in accordance with one or more measurements of the set of aperiodic narrowband reference signals. The operations of 1120 may be performed in accordance with examples as disclosed herein. In some examples, aspects of the operations of 1120 may be performed by a cell switch manager 740 as described with reference to FIG. 7.

At 1125, the method may include receiving a second control message including an indication of a second set of aperiodic narrowband reference signals for a subchannel of an additional secondary cell that is deactivated. The operations of 1125 may be performed in accordance with examples as disclosed herein. In some examples, aspects of the operations of 1125 may be performed by a measurement manager 750 as described with reference to FIG. 7.

At 1130, the method may include receiving the second set of aperiodic narrowband reference signals via the subchannel of the additional secondary cell in accordance with the second control message. The operations of 1130 may be performed in accordance with examples as disclosed herein. In some examples, aspects of the operations of 1130 may be performed by a measurement manager 750 as described with reference to FIG. 7.

At 1135, the method may include transmitting a report indicating one or more measurements of the additional secondary cell based on receiving the second set of aperiodic narrowband reference signals. The operations of 1135 may be performed in accordance with examples as disclosed herein. In some examples, aspects of the operations of 1135 may be performed by a measurement manager 750 as described with reference to FIG. 7.

The following provides an overview of aspects of the present disclosure:

Aspect 1: A method for wireless communications at a UE, comprising:
receiving control signaling indicating a primary cell and one or more secondary cells;
receiving a control message indicating activation of a secondary cell of the one or more secondary cells, the control message comprising an indication of a set of aperiodic narrowband reference signals for a subchannel of the secondary cell; receiving the set of aperiodic narrowband reference signals via the subchannel of the secondary cell in accordance with the control message; and communicating one or more messages via the secondary cell in accordance with one or more measurements of the set of aperiodic narrowband reference signals.

Aspect 2: The method of aspect 1, further comprising: receiving, via the control signaling, an indication of a set of candidate time and frequency resources for the set of aperiodic narrowband reference signals; and receiving, via the control message, an indication of time and frequency resources of the set of candidate time and frequency resources for the subchannel of the secondary cell, wherein the set of aperiodic narrowband reference signals are received via the indicated time and frequency resources.

Aspect 3: The method of any of aspects 1 through 2, further comprising:
receiving, via the control signaling, an indication of a set of candidate frequency resources for the set of aperiodic narrowband reference signals; and receiving, via the control message, an indication of time resources for the set of aperiodic narrowband reference signals and an indication of frequency resources of the set of candidate frequency resources for the subchannel of the secondary cell, wherein the set of aperiodic narrowband reference signals are received via the time and frequency resources.

Aspect 4: The method of any of aspects 1 through 3, further comprising:
receiving, via the control message, an indication of a resource allocation of time and frequency resources for the set of aperiodic narrowband reference signals, wherein the set of aperiodic narrowband reference signals are received via the indicated time and frequency resources.

Aspect 5: The method of any of aspects 1 through 4, further comprising:
receiving, via the control signaling, the control message, or both, an indication of time and frequency resources for receiving a first aperiodic narrowband reference signal, wherein time and frequency resources of a remainder of the set of aperiodic narrowband reference signals are based at least in part on the indication of the time and frequency resources for the first aperiodic narrowband reference signal.

Aspect 6: The method of any of aspects 1 through 5, wherein each aperiodic narrowband reference signal of the set of aperiodic narrowband reference signals comprise a primary synchronization signal, a secondary synchronization reference signal, a physical broadcast channel, or any combination thereof.

Aspect 7: The method of any of aspects 1 through 6, wherein receiving the control message comprising the indication of the set of aperiodic narrowband reference signals is based at least in part on the secondary cell being a known cell at the UE, the secondary cell being an unknown cell at the UE, the secondary cell being located within a first bandwidth or frequency range, a received transmission configuration indicator state at the UE, or any combination thereof.

Aspect 8: The method of any of aspects 1 through 7, wherein one or more occasions of a plurality of SSBs and one or more occasions of the set of aperiodic narrowband reference signals do not align across a set of component carriers.

Aspect 9: The method of any of aspects 1 through 8, wherein a first aperiodic narrowband reference signal of the set of aperiodic narrowband reference signals is received at least a threshold time offset after reception of the control message.

Aspect 10: The method of any of aspects 1 through 9, further comprising:
transmitting a capability message indicating that the UE supports dynamic activation of the one or more secondary cells, wherein receiving the control message is based at least in part on the capability message.

Aspect 11: The method of any of aspects 1 through 10, further comprising:
receiving a second control message comprising an indication of a second set of aperiodic narrowband reference signals for a subchannel of an additional secondary cell that is deactivated; receiving the second set of aperiodic narrowband reference signals via the subchannel of the additional secondary cell in accordance with the second control message; and transmitting a report indicating one or more measurements of the additional secondary cell based at least in part on receiving the second set of aperiodic narrowband reference signals.

Aspect 12: The method of any of aspects 1 through 11, wherein the control message comprises a MAC control element (CE), or a DCI message.

Aspect 13: The method of any of aspects 1 through 12, wherein control signaling comprises an indication of a plurality of periodic synchronization signal blocks (SSBs) for at least the primary cell.

Aspect 14: A UE for wireless communications, comprising one or more memories storing processor-executable code, a transceiver, and one or more processors coupled with the one or more memories and the transceiver, the one or more processors configured to cause the UE to perform a method of any of aspects 1 through 13.

Aspect 15: A UE for wireless communications, comprising at least one means for performing a method of any of aspects 1 through 13.

Aspect 16: A non-transitory computer-readable medium storing code for wireless communications, the code comprising instructions executable by one or more processors to perform a method of any of aspects 1 through 13.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code;
a transceiver, and
one or more processors coupled with the one or more memories and the transceiver, the one or more processors configured to:
receive, via the transceiver, first control signaling indicating a primary cell and one or more secondary cells;
receive, via the transceiver, second control signaling indicating activation of a secondary cell of the one or more secondary cells, the second control signaling comprising an indication of a set of aperiodic narrowband reference signals for a subchannel of the secondary cell;
receive, via the transceiver, the set of aperiodic narrowband reference signals via the subchannel of the secondary cell in accordance with the second control signaling; and
communicate, via the transceiver, one or more messages via the secondary cell in accordance with one or more measurements of the set of aperiodic narrowband reference signals.

2. The UE of claim 1, wherein the one or more processors are individually or collectively further configured to:
receive, via the transceiver and the control signaling, an indication of a set of candidate time and frequency resources for the set of aperiodic narrowband reference signals; and
receive, via the transceiver and the second control signaling, an indication of time and frequency resources of the set of candidate time and frequency resources for the subchannel of the secondary cell, wherein the set of aperiodic narrowband reference signals are received via the indicated time and frequency resources.

3. The UE of claim 1, wherein the one or more processors are individually or collectively further configured to:
receive, via the transceiver and the control signaling, an indication of a set of candidate frequency resources for the set of aperiodic narrowband reference signals; and
receive, via the transceiver and the second control signaling, an indication of time resources for the set of aperiodic narrowband reference signals and an indication of frequency resources of the set of candidate frequency resources for the subchannel of the secondary cell, wherein the set of aperiodic narrowband reference signals are received via the time and frequency resources.

4. The UE of claim 1, wherein the one or more processors are individually or collectively further configured to:
receive, via the transceiver and the second control signaling, an indication of a resource allocation of time and frequency resources for the set of aperiodic narrowband reference signals, wherein the set of aperiodic narrowband reference signals are received via the indicated time and frequency resources.

5. The UE of claim 1, wherein the one or more processors are individually or collectively further configured to:
receive, via the transceiver and the control signaling, the second control signaling, or both, an indication of time and frequency resources for receiving a first aperiodic narrowband reference signal, wherein time and frequency resources of a remainder of the set of aperiodic narrowband reference signals are based at least in part on the indication of the time and frequency resources for the first aperiodic narrowband reference signal.

6. The UE of claim 1, wherein each aperiodic narrowband reference signal of the set of aperiodic narrowband reference signals comprises a primary synchronization signal, a secondary synchronization reference signal, a physical broadcast channel, or any combination thereof.

7. The UE of claim 1, wherein reception of the second control signaling comprising the indication of the set of aperiodic narrowband reference signals is based at least in part on the secondary cell being a known cell at the UE, the secondary cell being an unknown cell at the UE, the secondary cell being located within a first bandwidth or frequency range, a received transmission configuration indicator state at the UE, or any combination thereof.

8. The UE of claim 1, wherein one or more occasions of a plurality of SSBs and one or more occasions of the set of aperiodic narrowband reference signals do not align across a set of component carriers.

9. The UE of claim 1, wherein a first aperiodic narrowband reference signal of the set of aperiodic narrowband reference signals is received at least a threshold time offset after reception of the second control signaling.

10. The UE of claim 1, wherein the one or more processors are individually or collectively further configured to:
transmit, via the transceiver, a capability message indicating that the UE supports dynamic activation of the one or more secondary cells, wherein receiving the second control signaling is based at least in part on the capability message.

11. The UE of claim 1, wherein the one or more processors are individually or collectively further configured to:
receive, via the transceiver, additional control signaling comprising an indication of a second set of aperiodic narrowband reference signals for a subchannel of an additional secondary cell that is deactivated;
receive, via the transceiver, the second set of aperiodic narrowband reference signals via the subchannel of the additional secondary cell in accordance with the additional control signaling; and
transmit, via the transceiver, a report indicating one or more measurements of the additional secondary cell based at least in part on receiving the second set of aperiodic narrowband reference signals.

12. The UE of claim 1, wherein the second control signaling comprises a media access control (MAC) control element (CE) or a downlink control information (DCI) message.

13. The UE of claim 1, wherein control signaling comprises an indication of a plurality of periodic synchronization signal blocks (SSBs) for at least the primary cell.

14. The UE of claim 1, the second control signaling comprises a single control message indicating the activation of the secondary cell and indicating the set of aperiodic narrowband reference signals for the subchannel of the secondary cell.

15. The UE of claim 1, the second control signaling comprises a first control message indicating the activation of the secondary cell and a second control message indicating the set of aperiodic narrowband reference signals for the subchannel of the secondary cell.

16. A method for wireless communications at a user equipment (UE), comprising:
receiving first control signaling indicating a primary cell and one or more secondary cells;
receiving second control signaling indicating activation of a secondary cell of the one or more secondary cells, the second control signaling comprising an indication of a set of aperiodic narrowband reference signals for a subchannel of the secondary cell;
receiving the set of aperiodic narrowband reference signals via the subchannel of the secondary cell in accordance with the second control signaling; and
communicating one or more messages via the secondary cell in accordance with one or more measurements of the set of aperiodic narrowband reference signals.

17. The method of claim 16, further comprising:
receiving, via the control signaling, an indication of a set of candidate time and frequency resources for the set of aperiodic narrowband reference signals; and
receiving, via the second control signaling, an indication of time and frequency resources of the set of candidate time and frequency resources for the subchannel of the secondary cell, wherein the set of aperiodic narrowband reference signals are received via the indicated time and frequency resources.

18. The method of claim 16, further comprising:
receiving, via the control signaling, an indication of a set of candidate frequency resources for the set of aperiodic narrowband reference signals; and
receiving, via the second control signaling, an indication of time resources for the set of aperiodic narrowband reference signals and an indication of frequency resources of the set of candidate frequency resources for the subchannel of the secondary cell, wherein the set of aperiodic narrowband reference signals are received via the time and frequency resources.

19. The method of claim 16, further comprising:
receiving, via the second control signaling, an indication of a resource allocation of time and frequency resources for the set of aperiodic narrowband reference signals, wherein the set of aperiodic narrowband reference signals are received via the indicated time and frequency resources.

20. A non-transitory computer-readable medium storing code for wireless communications, the code comprising instructions executable by one or more processors to:
receive first control signaling indicating a primary cell and one or more secondary cells;
receive second control signaling indicating activation of a secondary cell of the one or more secondary cells, the second control signaling comprising an indication of a set of aperiodic narrowband reference signals for a subchannel of the secondary cell;
receive the set of aperiodic narrowband reference signals via the subchannel of the secondary cell in accordance with the second control signaling; and
communicate one or more messages via the secondary cell in accordance with one or more measurements of the set of aperiodic narrowband reference signals.
